(19) United States
(12) Patent Application Publication
(10) Pub. No.: US 2026/0299872 A1
(43) Pub. Date: Oct. 1, 2026

(54) ELECTRONIC DEVICE AND METHOD FOR PERFORMING AUDIO COMMUNICATION BETWEEN FIRST SPACE AND SECOND SPACE

(71) Applicant: Realtek Semiconductor Corp., HsinChu (TW)

(72) Inventors: Chung-Shih Chu, HsinChu (TW); Chieh-Min Tsai, HsinChu (TW); Tien-Chiu Hung, HsinChu (TW)

(73) Assignee: Realtek Semiconductor Corp., HsinChu (TW)

(21) Appl. No.: 19/630,387

(22) Filed: Mar. 26, 2026

(30) Foreign Application Priority Data
Mar. 27, 2025 (TW) 114111721

(51) Int. Cl. G06F 3/16; G10L 17/06; H04L 65/1089; H04L 65/1096; H04L 65/403; H04M 3/56; H04R 1/08; H04R 3/00; H04R 3/02; H04R 3/04; H04R 29/00; H04W 16/18; H04W 84/20

(52) U.S. Cl. CPC G06F 3/162; G10L 17/06; H04L 65/1089; H04L 65/1096; H04L 65/403; H04M 3/568; H04R 1/08; H04R 3/005; H04R 3/02; H04R 3/04; H04R 29/002; H04R 29/005; H04W 16/18; H04M 2201/40; H04R 2420/07; H04W 84/20

(57) ABSTRACT

An electronic device and a method for performing audio communication between a first space and a second space are provided. The electronic device is one of multiple near-end devices at the first space and serves as a master device, and at least one other near-end device serves as a slave device. A front-end processing circuit of the master device generates a master signal according to sound signals received by a microphone of the master device, and a front-end processing circuit of the slave device generates a slave signal according to sound signals received by a microphone of the slave device. An audio processing circuit of the master device generates a final signal according to the master signal and a slave signal, and the master device transmits the final signal to a far-end device at the second space via an internet connection.

### BACKGROUND OF THE INVENTION

### 1. Field of the Invention

The present invention is related to audio conferences or multi-person voice calls, and more particularly, to an electronic device and a method for performing audio communication between a first space and a second space.

### 2. Description of the Prior Art

When making a conference call, attendees located in a same conference room may connect cloud-based video conferencing using their respective laptop computers to capture and transmit voice signals (voice signals of each attendee), instead of using a shared conference-call speaker to transmit the collective voice signals. Since each laptop computer receives the voice signals of each attendee in the same conference room, but comprises different respective delays due to the Internet or system factors, the timing of transmitting the voice signals of each attendee to a far-end location (e.g. another conference room) may be inconsistent, which degrades the clarity of the voice signals played and listened to by a far-end user. In addition, when multiple laptop computers in the conference room play and capture voice signals simultaneously, a loop formed by the playback/capture of the voice signals causes a howling feedback problem.

To avoid the above problems, the users typically enable the voice playback/ capture function of one laptop computer only, and disable the voice playback/capture functions of the remaining laptop computers (e.g. by setting them to a mute mode). As distances between the attendees in the conference room and the enabled laptop computer are inconsistent, however, this makes it difficult to optimize the overall sound quality. In addition, the voice signals of all attendees are captured by the same laptop computer, which makes the far-end user unable to determine which attendee a current voice comes from via a conference call software display screen.

Thus, there is a need for a novel mechanism and associated method to improve the playback/capture quality and overall user experience of multiple laptop computers making a conference call in the same space without introducing any side effect or in a way that is less likely to introduce side effects.

### SUMMARY OF THE INVENTION

An objective of the present invention is to provide an electronic device and a method for performing audio communication between a first space and a second space, which can improve user experiences of multiple users in a voice call (e.g. improving clarity of voice signals and reducing unwanted interference).

At least one embodiment of the present invention provides an electronic device for performing audio communication between a first space and a second space. Multiple near-end devices are located in the first space, and at least one far-end device is located in the second space, where the electronic device is one of the multiple near-end devices. The electronic device comprises a microphone, a front-end processing circuit and an audio processing circuit, where the microphone is configured to receive sound generated by a sound source located in the first space, the front-end processing circuit is configured to generate an audio signal according to the sound received by the microphone, and the audio processing circuit is configured to generate a final audio signal according to the audio signal. More particularly, when the electronic device is selected to be a master device, each of the other near-end devices is selected to be a slave device. The front-end processing circuit of the master device generates a master audio signal, and the front-end processing circuit of the slave device generates a slave audio signal, where the master device obtains the slave audio signal from the slave device via a transmission interface, and the audio processing circuit in the master device generates the final audio signal according to the master audio signal and the slave audio signal, to make the master device transmit the final audio signal to the at least one far-end device via an Internet connection.

At least one embodiment of the present invention provides a method for performing audio communication between a first space and a second space. The multiple near-end devices are located in the first space, and at least one far-end device is located in the second space. The method comprises: selecting one of the multiple near-end devices to be a master device and setting each of the other near-end devices to be a slave device; utilizing a microphone of the master device to receive audio signals generated by a sound source located in the first space, and accordingly generating a master audio signal; utilizing a microphone of the slave device to receive the audio signals generated by the sound source located in the first space, and accordingly generating a slave audio signal; utilizing the master device to obtain the slave audio signal from the slave device via a transmission interface; and utilizing an audio processing circuit of the master device to generate a final audio signal according to the master audio signal and the slave audio signal, to make the master device transmit the final audio signal to the at least one far-end device via an Internet connection.

The electronic device (which may be implemented in each of the multiple near-end devices) and the method provided by the embodiments of the present invention configures the microphones of the near-end devices as a microphone array, to thereby collect audio signals from respective users. In addition, sound signals collected by these microphones may be transmitted to the near-end device which is selected to be the master device, to allow the master device to process these sound signals, enabling a far-end user to receive the sound signals with better clarity. Alternatively, the sound signals collected by these microphones may be exchanged, allowing each device to obtain the sound signals collected by all microphones. Each device may select the master device according to a processing result of these sound signals, and then the selected master device may transmit the processed results of the sound signals to the far-end device. In addition, the embodiments of the present invention will not greatly increase additional costs. Thus, the present invention can improve user experiences of multiple users when performing a voice call without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating multiple near-end devices in a first space performing audio communication with at least one far-end device in a second space according to an embodiment of the present invention.

FIG. 2A is a diagram illustrating details of communication of multiple near-end devices in a first space according to an embodiment of the present invention.

FIG. 2B is a diagram illustrating multiple near-end devices performing communication via reception/transmission of ultrasound according to an embodiment of the present invention.

FIG. 3 is a diagram illustrating a working flow of a method for performing audio communication between a first space and a second space according to an embodiment of the present invention.

FIG. 4 is a diagram illustrating multiple near-end devices performing information exchange via Wi-Fi peer-to-peer transmission according to an embodiment of the present invention.

FIG. 5 is a diagram illustrating a working flow of multiple near-end devices performing communication via peer-to-peer protocol according to an embodiment of the present invention.

FIG. 6 is a diagram illustrating near-end devices performing information exchange via transmission/reception of ultrasound messages according to an embodiment of the present invention.

FIG. 7 is a diagram illustrating near-end devices performing communication via transmission/reception of ultrasound messages according to an embodiment of the present invention.

### DETAILED DESCRIPTION

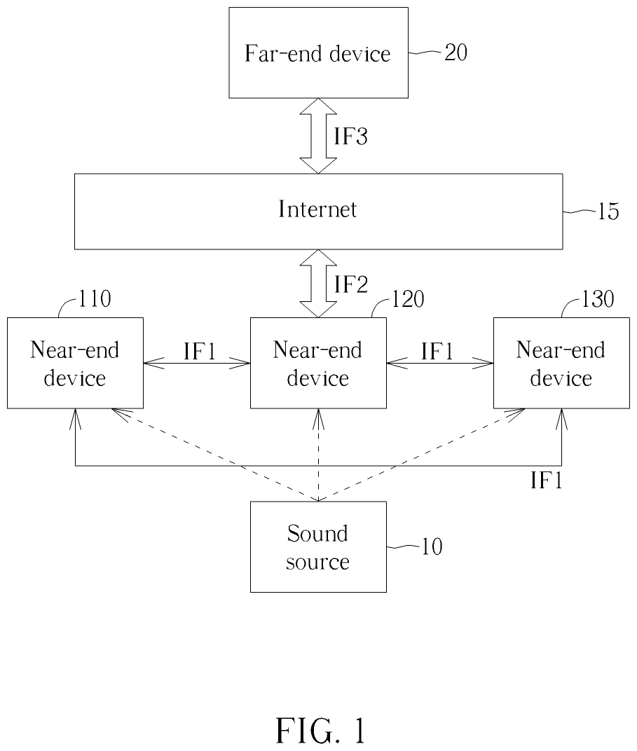

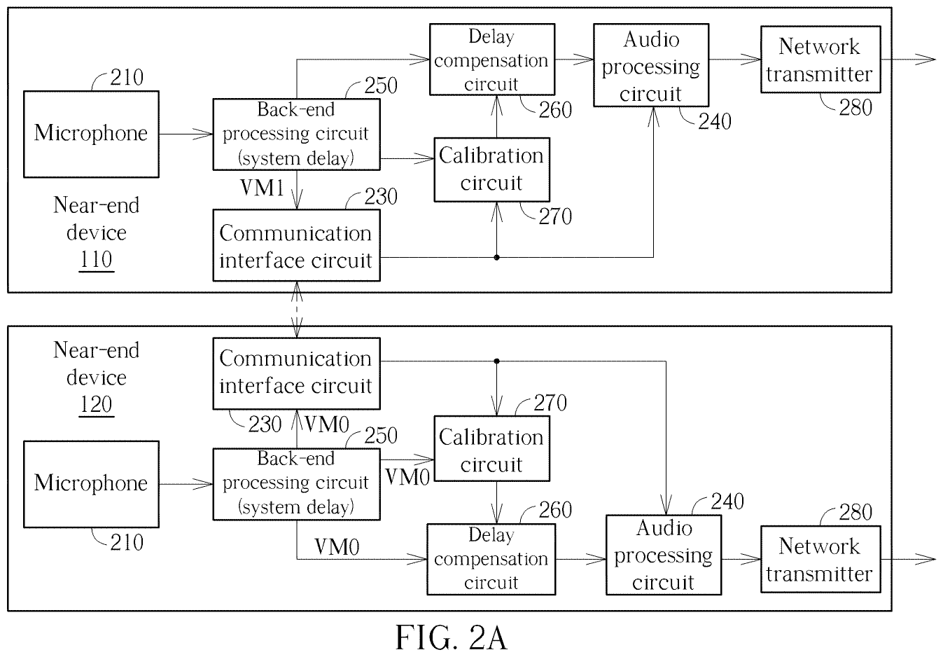

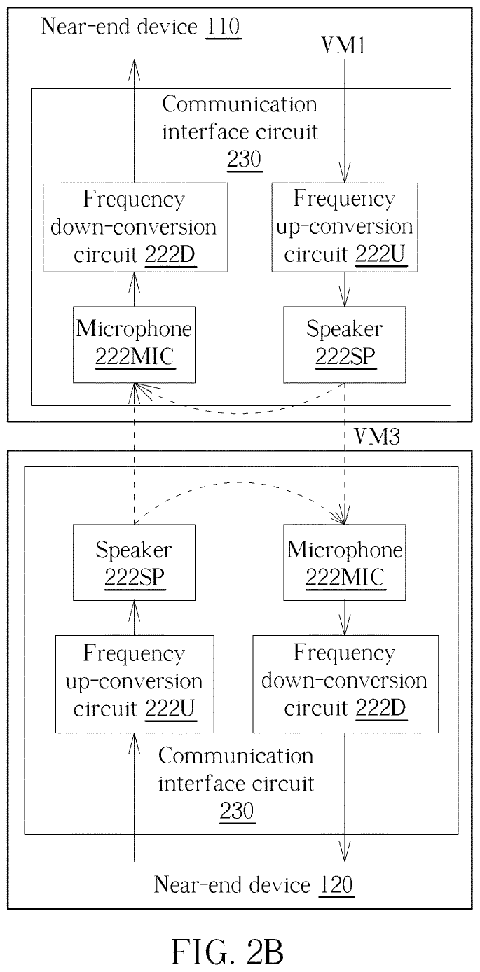

FIG. 1 is a diagram illustrating multiple near-end devices (e.g. near-end devices 110, 120 and 130) in a first space performing audio communication with at least one far-end device (e.g. a far-end device 20) in a second space according to an embodiment of the present invention, where the near-end devices 110, 120 and 130 may communicate with each other via a transmission interface IF1, the near-end device 120 may communicate with internet 15 via a transmission interface IF2, and the far-end device 20 may communicate with the internet 15 via a transmission interface IF3. For example, the near-end devices 110, 120 and 130 may make a conference call with the far-end device 20 via the internet 15, where the near-end devices 110, 120 and 130 may be multiple laptop computers located in the same conference room, and the far-end device 20 may be a laptop computer located in another space. In another example, the near-end devices 110, 120 and 130 may play an online game with the far-end device 20 via the internet 15, where the near-end devices 110, 120 and 130 may be multiple game consoles located in the same space, and the far-end device 20 may be a game console located in another space. In this embodiment, when a sound source 10 located in the first space emits sound signals (e.g. voice signals of a certain user speaking), these sound signals may be received by the near-end devices 110, 120 and 130, and corresponding audio signals are generated, where the near-end device 110 may obtain audio signals generated by the near-end devices 120 and 130 according to the sound signals emitted by the sound source 10 from the near-end devices 120 and 130 via the transmission interface IF1, the near-end device 120 may obtain audio signals generated by the near-end devices 110 and 130 according to the sound signals emitted by the sound source 10 from the near-end devices 110 and 130 via the transmission interface IF1, and the near-end device 130 may obtain audio signals generated by the near-end devices 110 and 120 according to the sound signals emitted by the sound source 10 from the near-end devices 110 and 120 via the transmission interface IF1. In this embodiment, the near-end device 120 may serve as a master device such as a group owner (GO) device, where the near-end device 120 may merge the audio signals generated by the near-end devices 110, 120 and 130 according to the sound signals generated by the sound source 10 into a final signal, to transmit the final signal to the far-end device 20 via an internet connection (e.g. the internet 15). It should be noted that when the near-end device 120 serves as the master device, the near-end devices 110 and 130 will not directly transmit the aforementioned audio signals to the internet 15. That is, the audio signals collected in the first space are collectively transmitted to the internet 15 by the master device (e.g. the near-end device 120).
FIG. 2A is a diagram illustrating related details of communication of the multiple near-end devices in the first space according to an embodiment of the present invention, where FIG. 2A takes the near-end devices 110 and 120 as an example for illustration, and implementation details involving the near-end device 130 may be deduced by analogy. As shown in FIG. 2A, each of the near-end devices 110 and 120 may comprise a microphone 210, a communication interface circuit 230, an audio processing circuit 240, a front-end processing circuit 250, a delay compensation circuit 260, a calibration circuit 270 and a network transmitter 280, where the front-end processing circuit 250 is coupled to the microphone 210, the communication interface circuit 230 is coupled to the front-end processing circuit 250, the calibration circuit 270 is coupled to the front-end processing circuit 250 and the communication interface circuit 230, the delay compensation circuit 260 is coupled to the calibration circuit 270, the audio processing circuit 240 is coupled to the delay compensation circuit 260 and the communication interface circuit 230, and the network transmitter 280 is coupled to the audio processing circuit 240. In specific, the microphone 210 is configured to receive the sound signals emitted by the sound source 10 located in the first space, where the front-end processing circuit 250 is configured to generate an audio signal according to the sound signals received by the microphone 210, or output a corresponding playback signal to a speaker (e.g. loudspeaker). More particularly, when the front-end processing circuit 250 performs the aforementioned operations, a corresponding system delay may be derived, where the calibration circuit 270 and the delay compensation circuit 260 may be configured to compensate for the aforementioned system delay, and adjust a delay of the audio signal accordingly. In addition, the audio processing circuit 240 is configured to generate a final audio signal according to the audio signal, and more particularly, configured to generate the final audio signal according to a compensation result output by the delay compensation circuit 260 to allow the network transmitter 280 to transmit (e.g. transmit to the far-end device 20). When the near-end device 120 is selected to be the master device, each of the other near-end devices (e.g. the near-end device 110) may be selected to be a slave device. For example, when the near-end device 120 shown in FIG. 1 is selected to be the master device, each of the near-end devices 110 and 130 may be selected to be the slave device. In this embodiment, the front-end processing circuit 250 of the master device (e.g. the near-end device 120) may generate a master audio signal such as an audio signal VM0, and the front-end processing circuit 250 of the slave device (e.g. the near-end device 110) may generate a slave audio signal such as an audio signal VM1, where the master device (e.g. the near-end device 120) may obtain the slave audio signal from the slave device (e.g. the near-end device 110) via the transmission interface IF1 (e.g. via the communication interface circuit 230 of the near-end device 120 and the communication interface circuit 230 of the near-end device 110), and the audio processing circuit 240 of the master device (e.g. the near-end device 120) may generate the final audio signal according to the master audio signal and the slave audio signal (e.g. performing audio processing such as beamforming or fusion on the master audio signal and the slave audio signal to generate the final audio signal, or selecting one of the master audio signal and the slave audio signal to be the final audio signal), to make the master device (e.g. the network transmitter 280 of the near-end device 120) transmit the final audio signal to the far-end device 20 via the internet 15. In some embodiments, each near-end device may obtain audio signals from other near-end devices, and each near-end device may process these audio signals to generate the final audio signal, where only the near-end device selected to be the master device (e.g. the near-end device 120) transmits the final audio signal to the far-end device 20 via the internet 15. For example, the near-end device 110 may obtain the audio signal of the near-end device 120 and the audio signal of the near-end device 130, the near-end device 120 may obtain the audio signal of the near-end device 110 and the audio signal of the near-end device 130, and the near-end device 130 may obtain the audio signal of the near-end device 110 and the audio signal of the near-end device 120, where each of the near-end devices 110, 120 and 130 may generate the final audio signal according to its own audio signal and the audio signals from other near-end devices, and only the near-end device selected to be the master device (e.g. the near-end device 120) may transmit the final audio signal to the far-end device 20 via the internet 15.

In one embodiment, when the near-end device 120 is a first near-end device connected to the audio communication between the first space and the second space among the multiple near-end devices, the near-end device 120 may be selected to be the master device such as a group owner (GO). For example, when the near-end device 120 shown in FIG. 1 is the first connected to an online conference call among the near-end devices 110, 120 and 130 (which means that the near-end devices 110 and 130 have not yet been connected to the online conference call at this moment), the near-end device 120 may start to broadcast an ultrasound message (e.g. a message carrying conference-related information such as a conference identification code) via a speaker therein. At this moment, the near-end device 120 does not receive ultrasound messages (e.g. ultrasound messages responding to the broadcast of the near-end device 120) generated from other near-end devices, so the near-end device 120 may be set to be the master device. When the other near-end devices such as 110 and 130 are connected to the online conference call after the near-end device 120 (or enter the first space after the near-end device 120), the near-end devices 110 and 130 may transmit ultrasound signals (e.g. messages carrying conference-related information such as the conference identification code) respectively, and since the near-end device 120 has been set to be the master device, the near-end device 120 may reply with corresponding ultrasound reply messages in response to the ultrasound signals transmitted by the near-end devices 110 and 130 respectively, and the near-end devices 110 and 130 may receive the ultrasound messages from the master device (e.g. the near-end device 120) and be set to be the slave device accordingly. Through the broadcast and communication of the ultrasound messages mentioned above, the near-end device 120 may accordingly determine whether other near-end devices exist in the same space (e.g. the first space). In addition, the speaker of each of the near-end devices 110, 120 and 130 may generate the test ultrasound signals, and the microphone 210 of the master device (e.g. the near-end device 120) may receive the test ultrasound signals generated by each of the near-end devices 110, 120 and 130, in order to detect the distance and angle information between the master device and each of the multiple near-end devices (e.g. between the near-end devices 110 and 120 or between the near-end devices 130 and 120), thereby establishing a topology of a microphone array and a speaker array formed by the near-end devices 110, 120 and 130. In another example, when the near-end device 120 enters the first space and attempts to receive ultrasound signals, if the near-end device 120 does not successfully receive ultrasound signals from other near-end devices, the near-end device 120 may be automatically set to be the master device, and then start to periodically broadcasting ultrasound signals. Thus, when the near-end devices 110 and 130 enter the first space and attempt to receive ultrasound signals, the near-end devices 110 and 130 may receive the ultrasound signal from the near-end device 120, and the near-end devices 110 and 130 may be automatically set to be the slave device accordingly.

In one embodiment, after the near-end devices 110, 120 and 130 are all connected to the online conference call, each near-end device among the near-end devices 110, 120 and 130 may test stability of connection to the internet of the each near-end device, wherein when a specific near-end device (e.g. the near-end device 120) is a near-end device having the best network stability among the near-end devices 110, 120 and 130, the near-end device 120 may be selected to be the master device, and the other near-end devices such as 110 and 130 may be set to be the slave device.

In some embodiments, after the near-end devices 110, 120 and 130 are all connected to the online conference call, each near-end device among the near-end devices 110, 120 and 130 may select a near-end device (e.g. the near-end device 120) located at a best (e.g. optimized) position (e.g. the topological center of the speaker array and/or the topological center of the microphone array) to be the master device according to the topology of the speaker array and/or the topology of the microphone array of the near-end devices 110, 120 and 130, and the other near-end devices (e.g. the near-end devices 110 and 130) may be set to be the slave device.

In some embodiments, the near-end device serving as the master device may be dynamically switched. Assume that the near-end device 120 is set to be the master device and the other near-end devices such as 110 and 130 are set to be the slave device at the beginning, wherein when the audio processing circuit 240 of the near-end device 120 determines that a difference between a slave audio indicator (e.g. the intensity or sound quality of the voice received by the microphone 210 of the near-end device 110) of the slave audio signal generated by a specific near-end device (e.g. the near-end device 110) among the near-end devices 110 and 130 and a master audio indicator of the master audio signal generated by the near-end device 120 (e.g. the intensity or sound quality of the voice received by the microphone 210 of the near-end device 120) reaches a predetermined threshold (e.g. the intensity of the voice received by the microphone 210 of the near-end device 110 is greater than the intensity of the voice received by the microphone 210 of the near-end device 120 and the difference between them is greater than the predetermined threshold), the near-end device 120 may be switched to be the slave device, and the near-end device 120 may then notify the specific near-end device (e.g. the near-end device 110) that it can be switched to be the master device via the transmission interface IF1. After completing the switching, the above operations executed by the master device (e.g. transmitting the final audio signal to the internet 15 via the transmission interface IF2) are executed by the near-end device 110 instead.

It should be noted that the switching of the master device and the slave device will cause data transmission of the transmission interface IF2 to be temporarily interrupted. If the near-end device 110 is directly switched to be the master device when someone is still speaking in the first space while the near-end device 120 serves as the master device, the speaker of the near-end device 110 will play the voice spoken in the first space before the switching as a far-end voice due to network delay right after switching to the master device. Thus, when the near-end device 120 is to release the position of the master device, it needs to wait for a delay time interval after releasing, and then notify the near-end device 110 to take over the position of the master device. In some embodiments, in order to avoid the voice in the first space from being interrupted due to the switching of the master device, the master device may determine whether the current moment is a suitable switching time point according to whether the intensity of the voice in the first space is low enough. For example, in order to avoid a far-end audio signal transmitted by the far-end device 20 to the master device (e.g. the near-end device 120) among the near-end devices 110, 120 and 130 from being affected by the switching of the master device and the slave device, when the audio processing circuit 240 of the near-end device 120 determines that the difference between the slave audio indicator of the slave audio signal generated by a specific near-end device (e.g. the near-end device 110) among the near-end devices 110 and 130 (e.g. the intensity or sound quality of the voice received by the microphone 210 of the near-end device 110) and the master audio indicator of the master audio signal generated by the near-end device 120 (e.g. the intensity or sound quality of the voice received by the microphone 210 of the near-end device 120) reaches the predetermined threshold (e.g. the intensity of the voice received by the microphone 210 of the near-end device 110 is greater than the intensity of the voice received by the microphone 210 of the near-end device 120 and the difference between them is greater than the predetermined threshold) and the intensity of a far-end audio signal transmitted from the far-end device 20 to the master device (e.g. the near-end device 120) is greater than the intensity threshold (which means that the far-end user is speaking and the volume is loud enough to allow the far-end device 20 to transmit a valid far-end audio signal to the master device), the near-end device 120 may continue to serve as the master device without performing the above switching until a condition where the intensity of the far-end audio signal is not greater than the intensity threshold occurs.

In this embodiment, the communication between the communication interface circuit 230 of the near-end device 120 and the communication interface circuit 230 of the near-end device 110 may be an example of the transmission interface IF1, where the communication interface circuit 230 of the near-end device 120 and the communication interface circuit 230 of the near-end device 110 may be a Wi-Fi peer-to-peer (P2P) transmission interface such as a Wi-Fi direct transmission interface, and the slave device (e.g. the near-end device 110) may perform Wi-Fi P2P transmission with the master device (e.g. the near-end device 120) via the Wi-Fi direct transmission interface, to transmit the slave audio signal such as the audio signal VM1 to the master device (e.g. the near-end device 120).

FIG. 2B is a diagram illustrating multiple near-end devices such as 110 and 120 performing communication via reception/transmission of ultrasound according to an embodiment of the present invention, where each of the communication interface circuit 230 of the near-end device 110 and the communication interface circuit 230 of the near-end device 120 may comprise a frequency up-conversion circuit 222U, a speaker 222SP, a microphone 222MIC and a frequency down-conversion circuit 222D. In some embodiments, the microphone 210 of the near-end device 110 shown in FIG. 2A and the microphone 222MIC in the communication interface circuit 230 of the near-end device 110 shown in FIG. 2B may be the same microphone, and the microphone 210 of the near-end device 120 shown in FIG. 2A and the microphone 222MIC in the communication interface circuit 230 of the near-end device 120 shown in FIG. 2B may be the same microphone. In some embodiments, the microphone 210 of the near-end device 110 shown in FIG. 2A and the microphone 222MIC in the communication interface circuit 230 of the near-end device 110 shown in FIG. 2B may be different microphones, and the microphone 210 of the near-end device 120 shown in FIG. 2A and the microphone 222MIC in the communication interface circuit 230 of the near-end device 120 shown in FIG. 2B may be different microphones. In some embodiments, the slave device (e.g. the near-end device 110) may utilize the frequency up-conversion circuit 222U therein to modulate the slave audio signal such as the audio signal VM1 onto an ultrasound signal to make the speaker 222SP of the slave device (e.g. the near-end device 110) play the ultrasound signal such as an audio signal VM3, and the microphone 222MIC of the master device (e.g. the near-end device 120) receives the ultrasound signal played by the speaker 222SP of the slave device (e.g. the near-end device 110), to allow the master device (e.g. the near-end device 120) to obtain the slave audio signal carried on the ultrasound signal via the frequency down-conversion circuit 222D therein. That is, the transmission/reception of ultrasound may be another example of the transmission interface IF1. Transmitting signals/information from the near-end device 120 to the near-end device 110 may be deduced by analogy, and details are omitted here for brevity.

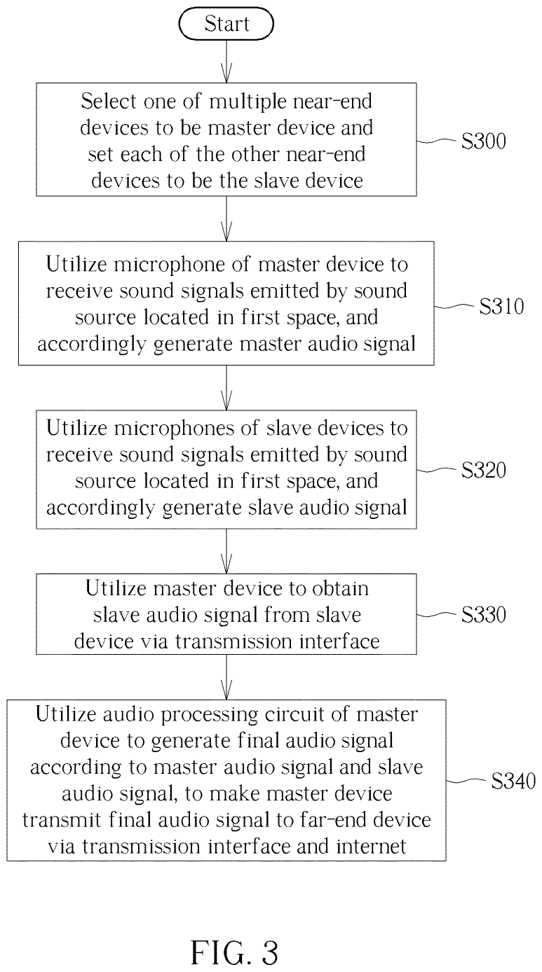

FIG. 3 is a diagram illustrating a working flow of a method for performing audio communication between the first space and the second space according to an embodiment of the present invention, where the working flow may be executed by a system formed by the near-end devices 110, 120 and 130 shown in FIG. 1. It should be noted that the working flow shown in FIG. 3 is only for illustrative purposes, and is not meant to be a limitation of the present invention. For example, one or more steps may be added, deleted or modified in the working flow shown in FIG. 3. In addition, these steps are not required to be executed exactly in the order shown in FIG. 3 if the same result can be obtained.

In Step S300, the system may select one of the near-end devices 110, 120 and 130 to be the master device (e.g. selecting the near-end device 120 to be the master device) and set each of the other near-end devices (e.g. the near-end devices 110 and 130) to be the slave device.

In Step S310, the system may utilize the microphone 210 of the master device (e.g. the near-end device 120) to receive the sound signals emitted by the sound source 10 located in the first space, and accordingly generate a master audio signal.

In Step S320, the system may utilize the microphones of the slave devices 110 and 130 to receive the sound signals emitted by the sound source located in the first space, and accordingly generate a slave audio signal (e.g. the slave device 110 generates a first slave audio signal according to the sound signals received by the microphone 210 of the slave device 110, and the slave device 130 emitted a second slave audio signal according to the sound signals received by the microphone 210 of the slave device 130).

In Step S330, the system may utilize the master device (e.g. the near-end device 120) to obtain the slave audio signal from the slave devices 110 and 130 via the transmission interface IF1 (e.g. obtaining the first slave audio signal from the slave device 110 and obtaining the second slave audio signal from the slave device 130).

In Step S340, the system may utilize the audio processing circuit 240 of the master device (e.g. the near-end device 120) to generate a final audio signal according to the master audio signal and the slave audio signal (e.g. according to the master audio signal, the first slave audio signal and the second slave audio signal), to make the master device (e.g. the near-end device 120) transmit the final audio signal to the far-end device 20 via the transmission interface IF2 and the internet 15.

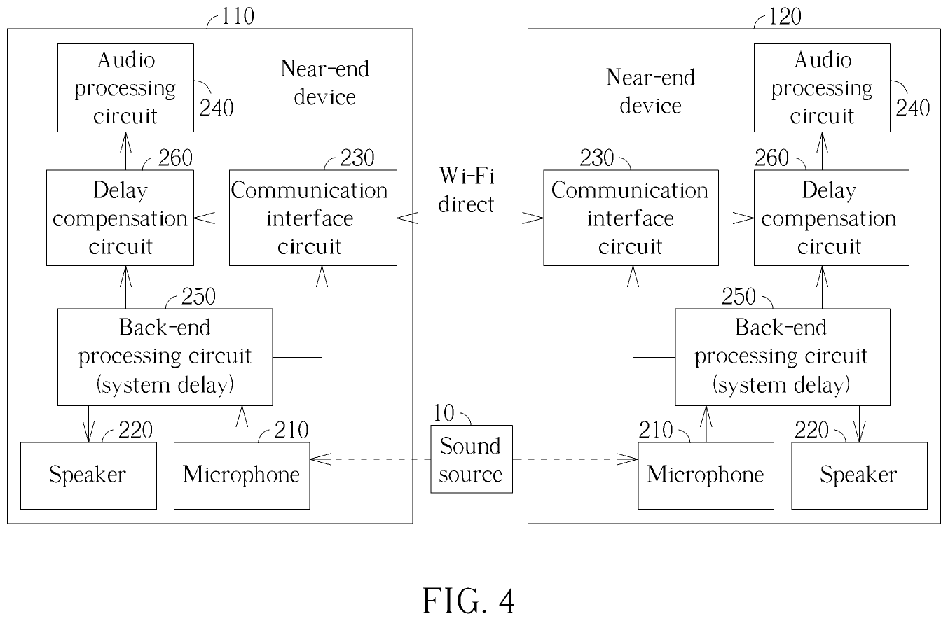

FIG. 4 is a diagram illustrating multiple near-end devices such as 110 and 120 performing information exchange via Wi-Fi P2P transmission such as Wi-Fi direct transmission according to an embodiment of the present invention. For convenience of explanation, assume that the near-end device 120 is selected to be the master device and the near-end device 110 is selected to be the slave device, where the internet 15 and the far-end device 20 are not illustrated in FIG. 4 for brevity. Before Wi-Fi direct transmission between the master device (e.g. the near-end device 120) and the slave device (e.g. the near-end device 110) is established, the speaker 220 of the near-end device 120 (which may be an example of the speaker 222SP of the near-end device 120 shown in FIG. 2B) may emit a master ultrasound signal carrying master Wi-Fi P2P information of the near-end device 120 (e.g. up-converting the master Wi-Fi P2P information to an ultrasound frequency band to generate the master ultrasound signal), to make the near-end device 110 obtain the master Wi-Fi P2P information of the near-end device 120 via the microphone 210 of the near-end device 110 (e.g. down-converting the master ultrasound signal received by the microphone 210 to obtain the master Wi-Fi P2P information). In addition, the speaker 220 of the near-end device 110 (which may be an example of the speaker 222SP of the near-end device 110 shown in FIG. 2B) may emit a slave ultrasound signal carrying slave Wi-Fi P2P information of the near-end device 110 (e.g. up-converting the slave Wi-Fi P2P information to the ultrasound frequency band to generate the slave ultrasound signal), to make the near-end device 120 obtain the slave Wi-Fi P2P information of the near-end device 110 via the microphone 210 of the near-end device 120 (e.g. down-converting the slave ultrasound signal received by the microphone 210 to obtain the slave Wi-Fi P2P information). That is, the near-end devices 110 and 120 may exchange Wi-Fi P2P information with each other via ultrasound signals, thereby establishing Wi-Fi direct transmission between the near-end devices 110 and 120. More particularly, the near-end device 120 may perform Wi-Fi direct transmission with the near-end device 110 according to the master Wi-Fi P2P information and the slave Wi-Fi P2P information, in order to obtain the slave audio signal from the near-end device 110. In some embodiments, the slave ultrasound signal and the master ultrasound signal may be generated in a same frequency band but at different times. In some embodiments, the slave ultrasound signal and the master ultrasound signal may be in different frequency bands.

After Wi-Fi direct transmission between the near-end devices 110 and 120 is established, the near-end device 120 may obtain the slave audio signal and timestamp information corresponding to the slave audio signal from the near-end device 110 via Wi-Fi direct transmission (which may be an example of the transmission interface IF1 shown in FIG. 1), the delay compensation circuit 260 of the near-end device 120 is configured to control a delay between the master audio signal and the slave audio signal according to the timestamp information to generate a delay compensation result, and the audio processing circuit 240 of the near-end device 120 may generate the final audio signal according to the delay compensation result. In detail, both the microphone 210 of the near-end device 110 and the microphone 210 of the near-end device 120 may receive the sound signals generated by the sound source 10, where the front-end processing circuit 250 of the near-end device 120 may generate the master audio signal and corresponding timestamp information (e.g. a timestamp recording a system delay such as T2 of the front-end processing circuit 250 of the near-end device 120) according to the voice signals received by the microphone 210 of the near-end device 120, and the front-end processing circuit 250 of the near-end device 110 may generate the slave audio signal and corresponding timestamp information (e.g. a timestamp recording a system delay such as T1 of the front-end processing circuit 250 of the near-end device 110) according to the sound signals received by the microphone 210 of the near-end device 110. More particularly, the communication interface circuit 230 may transmit the slave audio signal and the corresponding timestamp information to the communication interface circuit 230 of the near-end device 120 via Wi-Fi direct transmission, to allow the delay compensation circuit 260 of the near-end device 120 to obtain the slave audio signal and the corresponding timestamp information via the communication interface circuit 230 of the near-end device 120, and the delay compensation circuit 260 of the near-end device 120 may obtain the master audio signal and corresponding timestamp information from the front-end processing circuit 250 of the near-end device 120. Thus, the delay compensation circuit 260 may compare the timestamp information corresponding to the master audio signal and the timestamp information corresponding to the slave audio signal (e.g. comparing the system delay T1 of the front-end processing circuit 250 of the near-end device 110 and the system delay T2 of the front-end processing circuit 250 of the near-end device 120), and control the delay of the master audio signal and/or the slave audio signal according to a comparison result (e.g. a difference between the system delays T1 and T2), thereby generating the delay compensation result. More particularly, by comparing the timestamp information corresponding to the master audio signal and the timestamp information corresponding to the slave audio signal (e.g. comparing the system delay T1 of the front-end processing circuit 250 of the near-end device 110 and the system delay T2 of the front-end processing circuit 250 of the near-end device 120), the comparison result thereof may indicate a transmission delay caused by Wi-Fi direct and an overall result of the system delays T1 and T2.

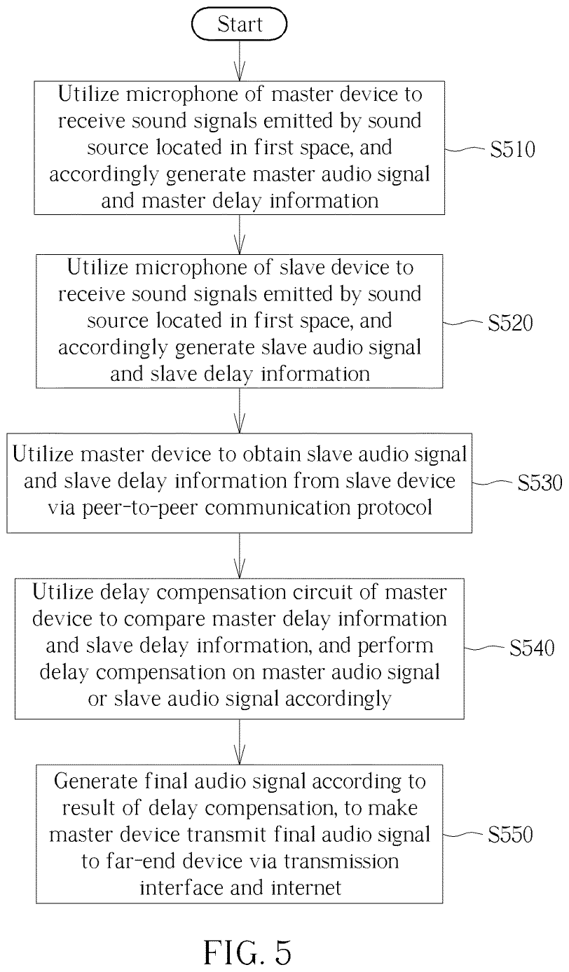

FIG. 5 is a diagram illustrating a working flow of multiple near-end devices such as 110 and 120 performing communication via peer-to-peer protocol (e.g. the Wi-Fi direct transmission mentioned above) according to an embodiment of the present invention, where the working flow may be executed by a system formed by the near-end devices 110 and 120 shown in FIG. 4. It should be noted that the working flow shown in FIG. 5 is only for illustrative purposes, and is not meant to be a limitation of the present invention. For example, one or more steps may be added, deleted or modified in the working flow shown in FIG. 5. In addition, if the same result can be obtained, these steps do not have to be executed in the exact order shown in FIG. 5.

In Step S510, the system may utilize the microphone 210 of the master device (e.g. the near-end device 120) to receive the sound signals emitted by the sound source 10 located in the first space, and accordingly generate the master audio signal and master delay information (e.g. the timestamp information recording the system delay T2).

In Step S520, the system may utilize the microphone 210 of the slave device (e.g. the near-end device 110) to receive the sound signals emitted by the sound source 10 located in the first space, and accordingly generate the slave audio signal and slave delay information (e.g. the timestamp information recording the system delay T1).

In Step S530, the system may utilize the master device (e.g. the near-end device 120) to obtain the slave audio signal and the slave delay information from the slave device (e.g. the near-end device 110) via the peer-to-peer communication protocol (e.g. the Wi-Fi direct transmission mentioned above).

In Step S540, the system may utilize the delay compensation circuit 260 of the master device (e.g. the near-end device 120) to compare the master delay information and the slave delay information, and perform delay compensation on the master audio signal or the slave audio signal accordingly.

In Step S550, the system (e.g. the audio processing circuit 240 of the near-end device 120) may generate the final audio signal according to a result of the delay compensation, to make the master device (e.g. the near-end device 120) transmit the final audio signal to the far-end device 20 via the transmission interface IF2 and the internet 15.

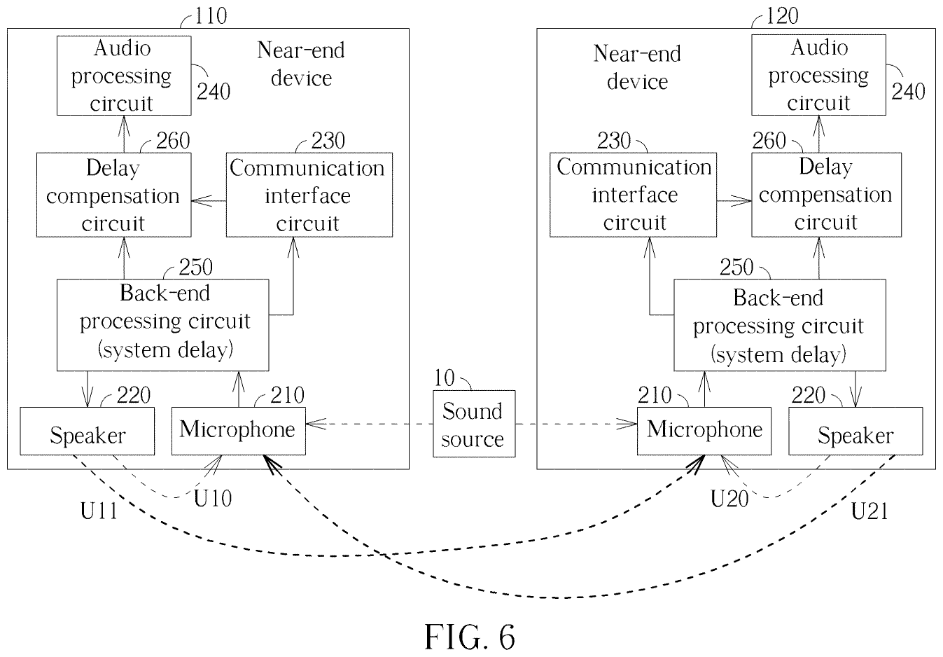

FIG. 6 is a diagram illustrating multiple near-end devices such as 110 and 120 performing information exchange via transmission/reception of ultrasound signals according to an embodiment of the present invention. For convenience of explanation, assume that the near-end device 120 is selected to be the master device and the near-end device 110 is selected to be the slave device, where the internet 15 and the far-end device 20 are not illustrated in FIG. 4 for brevity. In this embodiment, the near-end device 110 may carry the slave audio signal on a slave ultrasound signal U11 (e.g. frequency up-converting the slave audio signal to the ultrasound frequency band to generate the slave ultrasound signal U11) and output the slave ultrasound signal U11 via the speaker 220 of the near-end device 110, to make the microphone 210 of the near-end device 120 receive the slave ultrasound signal U11, thereby obtaining the slave audio signal carried on the slave ultrasound signal U11 (e.g. frequency down-converting the slave ultrasound signal U11 received by the microphone 210 to obtain the slave audio signal). In addition, the near-end device 120 may carry the master audio signal on a master ultrasound signal U21 (e.g. frequency up-converting the master audio signal to the ultrasound frequency band to generate the master ultrasound signal U21) and output the master ultrasound signal U21 via the speaker 220 of the near-end device 120, to make the microphone 210 of the near-end device 110 receive the master ultrasound signal U21, thereby obtaining the slave audio signal carried on the master ultrasound signal U21 (e.g. frequency down-converting the master ultrasound signal U21 received by the microphone 210 to obtain the master audio signal). In some embodiments, the slave ultrasound signal U11 generated by the speaker 220 of the near-end device 110 and the master ultrasound signal U21 generated by the speaker 220 of the near-end device 120 may be generated in a same frequency band but at different times. In some embodiments, the slave ultrasound signal U11 generated by the speaker 220 of the near-end device 110 and the master ultrasound signal U21 generated by the speaker 220 of the near-end device 120 may be in different frequency bands.

In addition, estimations of the system delay T1 caused by the front-end processing circuit 250 of the near-end device 110, the system delay T2 caused by the front-end processing circuit 250 of the near-end device 120, and a transmission delay caused by the near-end devices 110 and 120 performing signal transmission via the ultrasound signals (e.g. the slave ultrasound signal U11 or the master ultrasound signal U21) may also be executed via the transmission/reception of the ultrasound signals. For example, the speaker 220 of the near-end device 110 may emit a slave test ultrasound signal U10 according to a slave test signal (e.g. frequency up-converting the slave test signal to the ultrasound frequency band to generate the slave test ultrasound signal U10), and the microphone 210 of the near-end device 110 may receive the slave test ultrasound signal U10 and accordingly generate a slave feedback signal (e.g. frequency down-converting the slave test ultrasound signal U10 received by the microphone 210 to generate the slave feedback signal), where the near-end device 110 may generate slave delay information according to the slave test signal and the slave feedback signal (e.g. comparing the slave test signal and the slave feedback signal to obtain information of the system delay T1 mentioned above), to allow the near-end device 120 to obtain the slave delay information from the near-end device 110 via the transmission interface IF1 (e.g. via the Wi-Fi direct or the transmission/reception of ultrasound mentioned above). In addition, the speaker 220 of the near-end device 120 may emit a master test ultrasound signal U20 according to a master test signal (e.g. frequency up-converting the master test signal to the ultrasound frequency band to generate the master test ultrasound signal U20), and the microphone 210 of the near-end device 120 may receive the master test ultrasound signal U20 and accordingly generate a master feedback signal (e.g. frequency down-converting the master test ultrasound signal U20 received by the microphone 210 to generate the master feedback signal), where the near-end device 120 may generate master delay information according to the master test signal and the master feedback signal (e.g. comparing the master test signal and the master feedback signal to obtain information of the system delay T2 mentioned above), to allow the near-end device 110 to obtain the master delay information from the near-end device 120 via the transmission interface IF1 (e.g. via the Wi-Fi direct or the transmission/reception of ultrasound mentioned above). When the near-end device 120 serves as the master device, the delay compensation circuit 260 of the near-end device 120 is configured to control the delay between the master audio signal and the slave audio signal according to the master delay information and the slave delay information to generate a delay compensation result, and the audio processing circuit 240 of the near-end device 120 may generate the final audio signal according to the delay compensation result.

The difference between the embodiment of FIG. 6 and the embodiment of FIG. 4 is in the manner of information transmission between the near-end device 110 and the near-end device 120 (i.e. implementation manner of the transmission interface IF1) and the manner of estimating the system information T1 and T2, while other implementation details are the same, and are therefore omitted here for brevity. In addition, the implementation of the transmission interface IF1 in the embodiment of FIG. 4 is not limited to Wi-Fi direct; for example, it may be implemented by the transmission/reception of ultrasound. The implementation of the manner of estimating the system information T1 and T2 in the embodiment of FIG. 4 is not limited to recording the timestamp information; for example, it may be estimated by the transmission/reception of ultrasound. Similarly, the implementation of the transmission interface IF1 in the embodiment of FIG. 6 is not limited to the transmission/reception of ultrasound; for example, it may be implemented by Wi-Fi direct. The implementation of the manner of estimating the system information T1 and T2 in the embodiment of FIG. 6 is not limited to estimating by the transmission/reception of ultrasound; for example, it may be implemented by the manner of recording timestamp information.

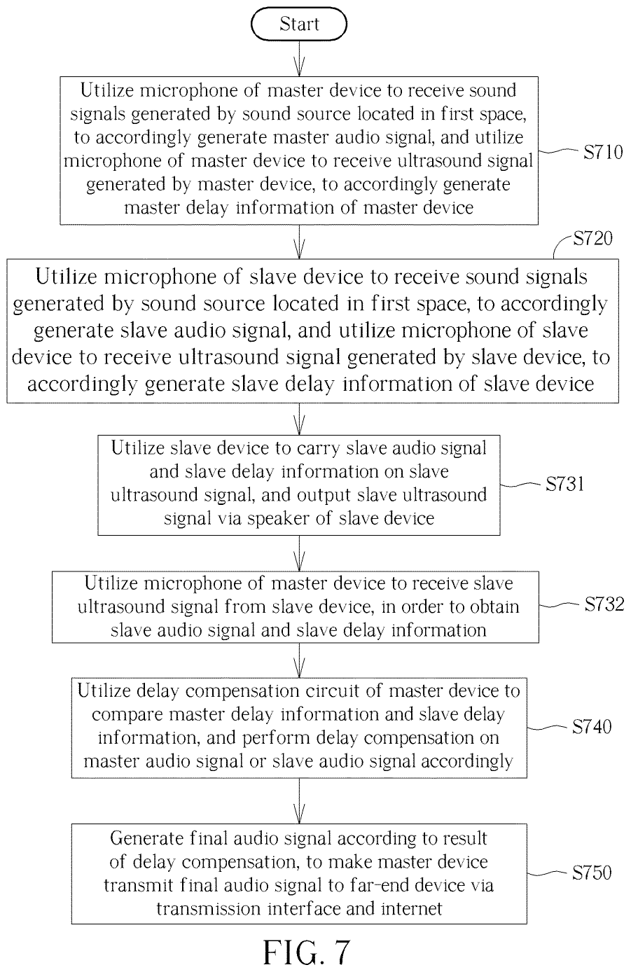

FIG. 7 is a diagram illustrating a working flow of multiple near-end devices such as 110 and 120 performing communication via transmission/reception of ultrasound signals according to an embodiment of the present invention, where the working flow may be executed by a system formed by the near-end devices 110 and 120 shown in FIG. 6. It should be noted that the working flow shown in FIG. 7 is only for illustrative purposes, and is not meant to be a limitation of the present invention. For example, one or more steps may be added, deleted or modified in the working flow shown in FIG. 7. In addition, if the same result can be obtained, these steps do not have to be executed in the exact order shown in FIG. 7.

In Step S710, the system may utilize the microphone 210 of the master device (e.g. the near-end device 120) to receive the sound signals generated by the sound source 10 located in the first space, and accordingly generate the master audio signal. In addition, the system may utilize the microphone 210 of the master device (e.g. the near-end device 120) to receive an ultrasound signal generated by the master device (e.g. the master test ultrasound signal U20 shown in FIG. 6), and accordingly generate the master delay information of the master device.

In Step S720, the system may utilize the microphone 210 of the slave device (e.g. the near-end device 110) to receive the sound signals generated by the sound source 10 located in the first space, and accordingly generate the slave audio signal. In addition, the system may utilize the microphone 210 of the slave device (e.g. the near-end device 110) to receive an ultrasound signal generated by the slave device (e.g. the slave test ultrasound signal U10 shown in FIG. 6), and accordingly generate the slave delay information of the slave device.

In Step S731, the system may utilize the slave device (e.g. the near-end device 110) to carry the slave audio signal and the slave delay information on a slave ultrasound signal (e.g. frequency up-converting the slave audio signal and the slave delay information to the ultrasound frequency band to generate the slave ultrasound signal), and output the slave ultrasound signal via the speaker 220 of the slave device (e.g. the near-end device 110).

In Step S732, the system may utilize the microphone 210 of the master device (e.g. the near-end device 120) to receive the slave ultrasound signal from the slave device (e.g. the near-end device 110), in order to obtain the slave audio signal and the slave delay information (e.g. frequency down-converting the slave ultrasound signal received by the microphone 210 to obtain the slave audio signal and the slave delay information).

In Step S740, the system may utilize the delay compensation circuit 260 of the master device (e.g. the near-end device 120) to compare the master delay information and the slave delay information, and perform delay compensation on the master audio signal or the slave audio signal accordingly.

In Step S750, the system (e.g. the audio processing circuit 240 of the near-end device 120) may generate the final audio signal according to a result of the delay compensation, to make the master device (e.g. the near-end device 120) transmit the final audio signal to the far-end device 20 via the transmission interface IF2 and the internet 15.

Since the microphones 210 of multiple near-end devices such as 110, 120 and 130 in the same space may be turned on simultaneously, these microphones may be regarded as a distributed microphone array. Signals received by the microphones 210 of different near-end devices may have different patterns or features such as different intensities, directionalities, sound qualities, etc., and thus the master device (e.g. the near-end device 120) may perform speaker classification according to these features, in order to record speeches of different users according to a result of the speaker classification during the process of the conference call. It should be noted that each of the near-end devices 110, 120 and 130 may obtain the signals received by the microphones 210 of other near-end devices, and perform audio processing on these signals respectively and then transmit processing results to other near-end devices, but the present invention is not limited thereto.

In summary, embodiments of the present invention provide multiple near-end devices in a same space which transmit sound signals received by respective microphones to each other via Wi-Fi direct or transmission/reception of ultrasound, in order to make these sound signals be capable of being collected into a single near-end device (e.g. a specific near-end device serving as a master device among these near-end devices). These sound signals may be regarded as sound signals collected by a microphone array, to allow the master device to perform related processing (e.g. beamforming or fusion) and transmit processing results to a far-end space via an internet connection, thereby optimizing quality of the voice signals transmitted to the far-end space. In addition, the embodiments of the present invention will not greatly increase additional costs. Thus, the present invention can improve user experiences of multiple users when performing a voice call without introducing any side effect or in a way that is less likely to introduce side effects.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. An electronic device for performing audio communication between a first space and a second space, wherein multiple near-end devices are located in the first space, at least one far-end device is located in the second space, the electronic device is one of the near-end devices, and the electronic device comprises:
a microphone, configured to receive sound signals emitted by a sound source located in the first space;
a front-end processing circuit, configured to generate an audio signal according to the sound signals received by the microphone; and
an audio processing circuit, configured to generate a final audio signal according to the audio signal;
wherein when the electronic device is selected to be a master device, each of the other near-end devices is selected to be a slave device, the front-end processing circuit of the master device generates a master audio signal, the front-end processing circuit of the slave device generates a slave audio signal, the master device obtains the slave audio signal from the slave device via a transmission interface, and the audio processing circuit of the master device generates the final audio signal according to the master audio signal and the slave audio signal, to make the master device transmit the final audio signal to the at least one far-end device via an internet connection.

2. The electronic device of claim 1, wherein when the electronic device is a first near-end device connected to the audio communication between the first space and the second space among the multiple near-end devices, the electronic device is selected to be the master device.

3. The electronic device of claim 1, wherein the master device performs speaker classification according to a pattern of the sound signals received by the microphone of each of the multiple near-end devices, in order to record speeches of different users according to the speaker classification.

4. The electronic device of claim 1, wherein each near-end device of the multiple near-end devices selects a near-end device having a best position to be the master device according to a topology of a speaker array and a microphone array, and the other near-end devices are set to be the slave device.

5. The electronic device of claim 1, wherein when the audio processing circuit of the electronic device determines that a difference between a slave audio indicator of the slave audio signal generated by a specific near-end device among the multiple near-end devices and a master audio indicator of the master audio signal reaches a predetermined threshold, the electronic device is switched to be the slave device, and the specific near-end device is switched to be the master device.

6. The electronic device of claim 1, wherein when the audio processing circuit of the electronic device determines that a difference between a slave audio indicator of the slave audio signal generated by a specific near-end device among the multiple near-end devices and a master audio indicator of the master audio signal reaches a switch threshold and an intensity of a far-end audio signal transmitted to the master device from the at least one far-end device is greater than an intensity threshold, the electronic device continues to serve as the master device.

7. The electronic device of claim 1, wherein the electronic device further comprise a speaker, the speaker of the master device generates a master ultrasound signal carrying master Wi-Fi peer-to-peer (P2P) information of the master device to make the slave device obtain the master Wi-Fi P2P information of the master device via the microphone of the slave device, the speaker of the slave device generates a slave ultrasound signal carrying slave Wi-Fi P2P information of the slave device to make the master device obtain the slave Wi-Fi P2P information of the slave device via the microphone of the master device, and the master device performs Wi-Fi P2P transmission according to the master Wi-Fi P2P information and the slave Wi-Fi P2P information, in order to obtain the slave audio signal from the slave device.

8. The electronic device of claim 1, wherein the electronic device further comprises a speaker, the speaker of each of the near-end devices generates a test ultrasound signal, and the microphone of the master device receives the test ultrasound signal generated from each of the near-end devices, in order to detect a distance and an angle between the master device and each of the multiple near-end devices, thereby establishing a topology of a microphone array and a speaker array formed by the multiple near-end devices.

9. The electronic device of claim 1, wherein the electronic device further comprises:
a delay compensation circuit, wherein the master device obtains the slave audio signal and timestamp information corresponding to the slave audio signal from the slave device via the transmission interface, and the delay compensation circuit of the master device is configured to control a delay between the master audio signal and the slave audio signal according to the timestamp information to generate a delay compensation result, and the audio processing circuit of the master device generates the final audio signal according to the delay compensation result.

10. The electronic device of claim 1, wherein the electronic device further comprises a speaker, and the slave device generates a slave ultrasound signal for carrying the slave audio signal and outputs the slave ultrasound signal via the speaker of the slave device, to make the microphone of the master device receives the slave ultrasound signal, thereby obtaining the slave audio signal carried by the slave ultrasound signal.

11. A method for performing audio communication between a first space and a second space, wherein multiple near-end devices are located in the first space, at least one far-end device is located in the second space, and the method comprises:
selecting one of the multiple near-end devices to be a master device and setting each of the other near-end devices to be a slave device;
utilizing a microphone of the master device to receive sound signals generated by a sound source located in the first space, and accordingly emitted a master audio signal;
utilizing a microphone of the slave device to receive the sound signals generated by the sound source located in the first space, and accordingly generating a slave audio signal;
utilizing the master device to obtain the slave audio signal from the slave device via a transmission interface; and
utilizing an audio processing circuit of the master device to generate a final audio signal according to the master audio signal and the slave audio signal, to make the master device transmit the final audio signal to the at least one far-end device via an internet connection.

12. The method of claim 11, wherein the step of selecting one of the multiple near-end devices to be the master device comprises:
selecting a first near-end device connected to the audio communication between the first space and the second among the multiple near-end devices to be the master device.

13. The method of claim 11, further comprising:
utilizing the master device to perform speaker classification according to a pattern of the voice signals received by the microphone of each of the multiple near-end devices, in order to record speeches of different users according to the speaker classification.

14. The method of claim 11, wherein the step of selecting one of the multiple near-end devices to be the master device comprises:
utilizing each near-end device of the multiple near-end devices to select a near-end device having a best position to be the master device according to a topology of a speaker array and a microphone array, and setting the other near-end devices to be the slave device.

15. The method of claim 11, further comprising:
in response to the audio processing circuit of an electronic device serving as the master device determining that a difference between a slave audio indicator of the slave audio signal generated by a specific near-end device among the multiple near-end devices and a master audio indicator of the master audio signal reaches a predetermined threshold, switching the electronic device to be the slave device, and switching the specific near-end device to be the master device.

16. The method of claim 11, further comprising:
in response to the audio processing circuit of an electronic device serving as the master device determining that a difference between a slave audio indicator of the slave audio signal generated by a specific near-end device among the multiple near-end devices and a master audio indicator of the master audio signal reaches a switch threshold and an intensity of a far-end audio signal transmitted to the master device from the at least one far-end device is greater than an intensity threshold, continuing utilizing the electronic device to serve as the master device.

17. The method of claim 11, wherein each of the master device and the slave device further comprise a speaker, and the method further comprises:
utilizing the speaker of the master device to generate a master ultrasound signal carrying master Wi-Fi peer-to-peer (P2P) information of the master device to make the slave device obtain the master Wi-Fi P2P information of the master device via the microphone of the slave device;
utilizing the speaker of the slave device to generate a slave ultrasound signal carrying slave Wi-Fi P2P information of the slave device to make the master device obtain the slave Wi-Fi P2P information of the slave device via the microphone of the master device; and
utilizing the master device to perform Wi-Fi P2P transmission according to the master Wi-Fi P2P information and the slave Wi-Fi P2P information, in order to obtain the slave audio signal from the slave device.

18. The method of claim 11, wherein each of the master device and the slave device further comprise a speaker, and the method further comprises:
utilizing the speaker of each of the near-end devices to generate a test ultrasound signal; and
utilizing the microphone of the master device to receive the test ultrasound signal generated from each of the near-end devices, in order to detect a distance and an angle between the master device and each of the multiple near-end devices, thereby establishing a topology of a microphone array and a speaker array formed by the multiple near-end devices.

19. The method of claim 11, wherein further comprising:
utilizing the master device to obtain the slave audio signal and timestamp information corresponding to the slave audio signal from the slave device via the transmission interface;
utilizing a delay compensation circuit of the master device to control a delay between the master audio signal and the slave audio signal according to the timestamp information to generate a delay compensation result; and
utilizing the audio processing circuit of the master device to generate the final audio signal according to the delay compensation result.

20. The method of claim 11, further comprising:
utilizing the slave device to generate a slave ultrasound signal for carrying the slave audio signal and output the slave ultrasound signal via a speaker of the slave device, to make the microphone of the master device receive the slave ultrasound signal, thereby obtaining the slave audio signal carried by the slave ultrasound signal.
